(19) United States
(12) Patent Application Publication
(10) Pub. No.: US 2015/0137560 A1
(43) Pub. Date: May 21, 2015

(54) ASSEMBLY INCLUDING A COMPRESSION-MOLDED COMPOSITE COMPONENT HAVING A SANDWICH STRUCTURE WITH A CELLULOSE-BASED CORE AND AT LEAST ONE FASTENER COMPONENT

(71) Applicant: GLOBAL IP HOLDINGS, LLC, Sterling Heights, MI (US)

(72) Inventors: Darius J. Preisler, Macomb, MI (US); Christopher A. Heikkila, Washington Township, MI (US)

(21) Appl. No.: 14/603,413

(22) Filed: Jan. 23, 2015

Related U.S. Application Data
(63) Continuation-in-part of application No. 13/479,974, filed on May 24, 2012.

(51) Int. Cl. B62D 25/20; B32B 7/12; B32B 3/12; B32B 3/06; B32B 3/26

(52) U.S. Cl. CPC B62D 25/20; B32B 3/06; B32B 3/26; B32B 3/12; B32B 7/12; B32B 2250/05; B32B 2305/024; B32B 2605/003
USPC 296/193.07; 428/99

(57) ABSTRACT

An assembly including a compression-molded composite component having a sandwich structure with a cellulose-based core and at least one fastener component is provided. The composite component has a first outer layer of fiber-reinforced thermoplastic material, a first sheet of thermoplastic adhesive, a second outer layer of fiber-reinforced thermoplastic material, a second sheet of thermoplastic adhesive, and a core of cellulose-based material and positioned between the outer layers. The outer layers are bonded to the core by the first and second sheets by press molding. Each fastener component has a fastener part having a length and width and a mounting part mounting the fastener part to the first outer layer.

### CROSS-REFERENCE TO RELATED APPLICATIONS

This application is a continuation-in-part of U.S. patent application Ser. No. 13/479,974 filed on May 24, 2012.

### TECHNICAL FIELD

This invention generally relates to assemblies including compression-molded composite components having sandwich structures with a cellulose-based core and, in particular, to such assemblies which have fastener components mounted in the composite components.

### OVERVIEW

Some compression-molded composites combine a light-weight, low-density core with fiber-reinforced thermoplastic skins or outer layers thereby resulting in a sandwich structure. The resulting composite component has a high stiffness-to-weight ratio thereby making it desirable for use in a wide variety of applications including load-bearing applications. In general, the thicker the core, the higher the load-bearing capacity of the composite component.

As a result of their high stiffness-to-weight ratio and load-bearing capacity, such compression-molded composites have been used as load floors in automotive applications and as skis or snowboards (i.e. sliding boards) in recreational applications.

It is highly desirable to secure hardware and other components to the composite components. In automotive applications, such as rear load-bearing load floors, it is desirable to provide attachment mechanisms at various locations to secure cargo to protect the cargo from sliding, rolling, etc. which tends to damage the cargo as well as other items or structures in the cargo area.

Because of the large forces that cargo as well as individuals can exert on the load floor, any attachment or fastening mechanism must be able to withstand not only large pull-out forces but also large push-in forces. Also, such attachment or fastening mechanisms must be able to withstand large torque forces to prevent the mechanisms from being “torqued out” of or “torqued into” the composite components.

The following U.S. patent documents are related to the present invention: Pat. Nos. 7,942,475; 7,713,011; 7,419,713; 7,059,815; 6,537,413; 6,050,630; 5,253,962; 5,074,726; Ser. Nos. 2012/0315429; 2010/0086728; 2007/0258786 and 2005/0189674.

Despite the above, there is an ongoing need for low cost, light weight compression-molded composite compounds having a sandwich structure for use in assemblies which also include fastener components.

### SUMMARY OF EXAMPLE EMBODIMENTS

An object of at least one embodiment of the present invention is to provide an assembly including a low cost, light weight, compression-molded composite component having a sandwich structure with a cellulose-based core and at least one fastener component wherein each fastener component is capable of fastening or securing one or more objects to the composite structure with a relatively high pull-out force.

In carrying out the above object and other objects of at least one embodiment of the present invention, an assembly including a compression-molded composite component having a sandwich structure and at least one fastener component is provided. The composite component has a first outer layer of fiber-reinforced thermoplastic material, a first sheet of thermoplastic adhesive, a second outer layer of fiber-reinforced thermoplastic material, a second sheet of thermoplastic adhesive, and a core of cellulose-based material and positioned between the outer layers. The core has a large number of cavities. The outer layers are bonded to the core by the first and second sheets by press molding. Each fastener component has a fastener part having a length and width and a mounting part mounting the fastener part to the first outer layer. The mounting part has a pair of holding faces that oppose each other and define a space therebetween. A portion of the first outer layer is positioned in the space in engagement with the faces to prevent the fastener part from moving along its length relative to the first outer layer.

The holding faces may be annular holding faces, the space may be an annular space and the portion of the first outer layer may be an annular portion.

The length of the fastener part may be greater than the width of the first outer layer but less than the width of the composite component.

The fastener part may be cylindrical wherein the cylindrical fastener part has an axis defined as being central to the fastener part.

At least one of the holding faces may have a set of locking formations spaced about the axis of the fastener part to prevent rotary movement of the fastener component relative to the first outer layer.

The holding faces may be annular holding faces wherein the annular holding faces are oriented to face axially along the axis.

The fastener part may be threaded such as internally threaded.

The thermoplastic adhesive of the sheets may be a hot-melt adhesive.

The first outer layer may be a load-bearing layer and the composite component may be a vehicle floor panel.

The core may be a paper cellular core and may have a honeycomb structure.

The assembly may further include an opening which extends completely through the first outer layer and at least partially extends through the core towards the second outer layer wherein the mounting part mounts the fastener component in the opening.

The opening may be a circular opening and the fastener component may be a generally cylindrical component.

Further in carrying out the above object and other objects of the at least one embodiment of the present invention, an assembly including a compression-molded composite component having a sandwich structure and at least one fastener component is provided. The composite component has a first outer layer of a fiber-reinforced thermoplastic material and having a circular opening which extends completely through the layer, a first sheet of thermoplastic adhesive, a second outer layer of fiber-reinforced thermoplastic material, a second sheet of thermoplastic adhesive, and a core of cellulose-based material and positioned between the outer layers and having a large number of cavities. The outer layers are bonded to the core by the first and second sheets by press molding. Each fastener component is generally cylindrical and has a cylindrical, threaded fastener part having a length, a width and an axis defined as being central to the fastener part and a mounting part mounting the fastener part in the opening in the first outer layer. The mounting part has a pair of annular holding faces that oppose each other and are oriented to face axially along the axis. The holding faces define an annular space therebetween. An annular portion of the first outer layer is positioned in the space in engagement with the faces to prevent the fastener part from moving along its axis relative to the first outer layer.

Still further in carrying out the above object and other objects of at least one embodiment of the present invention, a vehicle floor panel assembly is provided. The assembly includes a compression-molded composite component having a sandwich structure and at least one fastener component. The composite component has a load-bearing, first outer layer of a fiber-reinforced thermoplastic material and having a circular opening which extends completely through the layer, a first sheet of thermoplastic adhesive, a second outer layer of fiber-reinforced thermoplastic material, a second sheet of thermoplastic adhesive, and a core of cellulose-based material and positioned between the outer layers and having a large number of cavities. The outer layers are bonded to the core by the first and second sheets by press molding. Each fastener component is generally cylindrical and has a cylindrical, threaded fastener part having a length, a width and an axis defined as being central to the fastener part and a mounting part mounting the fastener part in the opening in the first outer layer. The mounting part has a pair of annular holding faces that oppose each other and are oriented to face axially along the axis. The holding faces define an annular space therebetween. An annular portion of the first outer layer is positioned in the space in engagement with the faces to prevent the fastener part from moving along its axis relative to the first outer layer.

Each of the holding faces may have a set of locking formations spaced about the axis of the fastener part to prevent rotary movement of the fastener component about the axis relative to the first outer layer.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### BRIEF DESCRIPTION OF THE DRAWINGS

FIG. 1 is an environmental view, partially broken away, of a load floor assembly constructed in accordance with at least one embodiment of the present invention and positioned at the rear of an automotive vehicle;

FIG. 2 is a view, partially broken away and in cross section, taken along lines 2-2 of FIG. 1 and showing a fastener component mounted in a hole formed through a first outer layer of a composite component of the assembly;

FIG. 3 is an end view of the fastener component of FIG. 2 prior to insertion in the composite component;

FIG. 4 is a side elevational view of the fastener component prior to insertion;

FIG. 5 is a sectional view of the fastener component taken along lines 5-5 of FIG. 4;

FIG. 6 is a side sectional view showing a stack of various separate sheets or layers of thermoplastic and cellulose-based material prior to being compression molded into a composite component having a sandwich structure;

FIG. 7 is a top perspective view, partially broken away and in cross section, of the composite component of FIG. 6 prior to mounting of the fastener component;

FIG. 8 is a view similar to the view of FIG. 7 but providing a bottom perspective view;

FIG. 9 is a top plan view, partially broken away, of a reinforced thermoplastic skin having substantially parallel, visible fibers; and

FIG. 10 is a view similar to the view of FIG. 9 but with substantially randomly oriented visible fibers.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

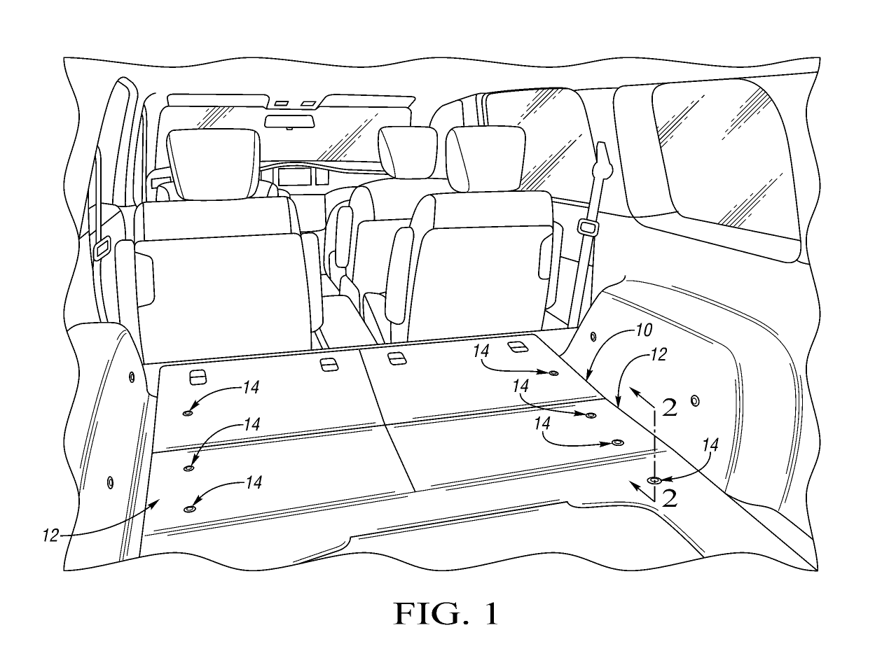

Referring now to the drawing figures, FIG. 1 shows a vehicle floor panel assembly such as a load floor assembly, generally indicated at 10, positioned or supported at the rear of an automotive vehicle. The assembly 10 includes one or more compression-molded composite components, generally indicated at 12, having a composite structure and at least one, and, preferably, a plurality of fastener components, each of which is generally indicated at 14.

The composite component 12 includes a load-bearing first outer layer, generally included at 16, a second outer layer generally included at 18, and a core, generally included at 20, between the outer layers 16 and 18 and having a large number of cavities 22. The outer layers 16 and 18 are bonded to the core 20 by press molding typically after pre-heating the outer layers 16 and 18. The outer layers 16 and 18 are preferably fiber-reinforced thermoplastic layers. The thermoplastic may be a polyolefin such as polypropylene. The thermoplastic may also be polyurethane. The fiber-reinforcement may be a glass mat, a natural fiber mat, a woven or non-woven mat.

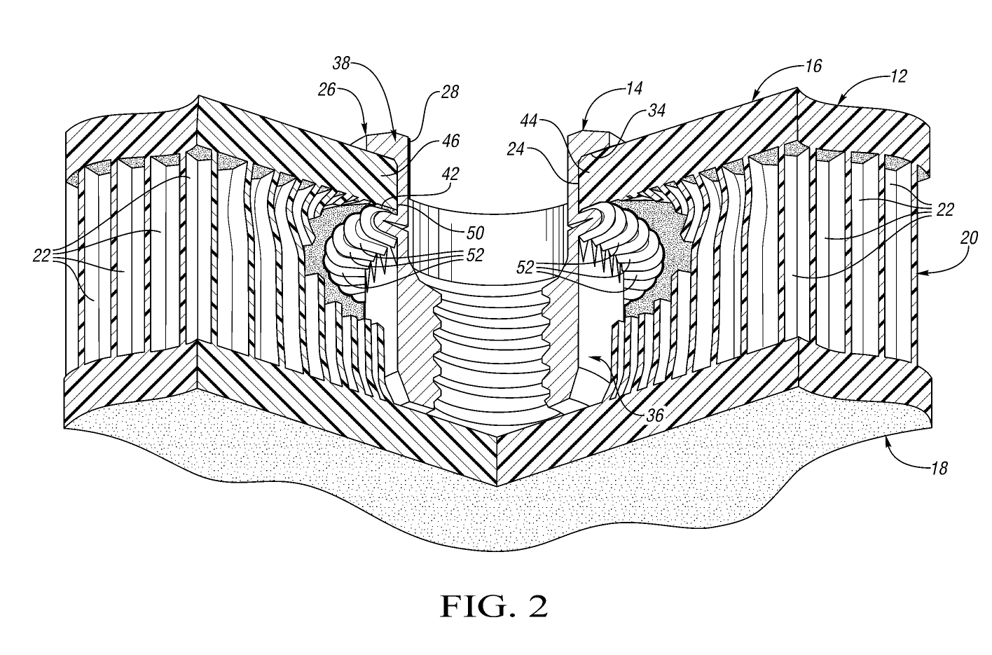

The core 20 may be a cellular core having a thermoplastic honeycomb structure as shown in FIG. 2. The core 20 may also be made of polypropylene honeycomb, aluminum honeycomb, balsa and polyurethane foam. The resulting composite component 12 typically includes a lightweight, low density core such as the core 20 together with fiber-reinforced thermoplastic skins or layers such as the layers 16 and 18.

The composite component 12 may be compression or press molded using a variety of technologies which use a low temperature, compression molding apparatus. For example, the core 20 and the layers 16 and 18 are preferably generally of the type shown in U.S. patent documents Nos. 6,537,413; 6,050,630; and No. 2005/0189674.

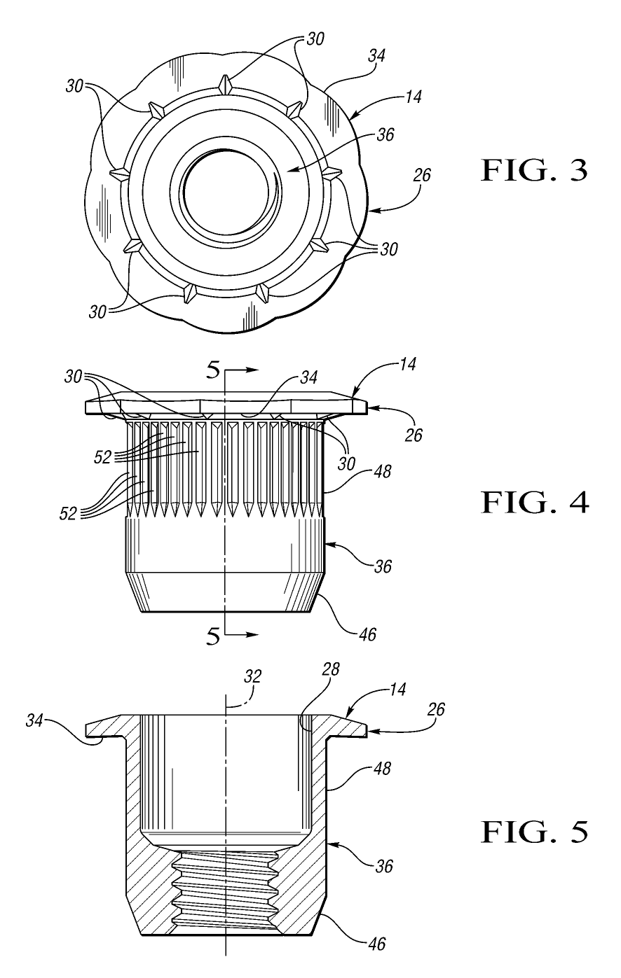

After compression or press molding, at least one hole and, preferably, a plurality of holes 24 are formed in the composite component 12 such as by cutting through the first outer layer 16, through the core 20 right up to but not through the second outer layer 18. A rivot-like fastener such as the fastener component 14 is positioned in each of the holes 24. Each of the fastener components 14 is generally of the type shown in U.S. patent publications 7,713,011 and 2007/0258786 wherein the preferred fastener component is called an M4 insert, installed by use of a hydro-pneumatic tool both of which are available from Sherex Fastening Solutions LLC of New York. One of the fastener components 14 is illustrated in FIGS. 3-5 prior to installation wherein during installation an outer sleeve of the fastener component 14 is deformed, the deformed component 14 being shown in FIG. 2.

The fastener component 14 typically has a relatively large annular flange, generally included at 26, an open end 28 and a plurality of integrally formed locking formations or wedges 30 circumferentially spaced about an axis 32 of the component 14 on an annular face 34 of the flange 26 to prevent rotary motion of the fastener component 14 relative to the first outer layer 16 after installation. The wedges 30 grip into the outer surface of the first outer layer 16 after the fastener component 14 is attached to the first outer layer 16.

In general, each fastener component 14 includes a cylindrical fastener portion or part, generally included at 36, having a length and width, and a mounting portion or part, generally indicated at 38, for mounting the fastener part 36 to the first outer layer 16. The mounting part 38 includes the annular holding face 34 and an annular holding face 42 that oppose each other and define an annular space 44 therebetween. An annular portion 46 of the first outer layer 16 is positioned in the space 44 in engagement with the faces 34 and 42 to prevent the fastener part 36 from moving along its length or axis 32 relative to the first outer layer 16. The axis 32 is generally central to the fastener part 36 and the annular holding faces 34 and 42 are oriented to face axially along the axis 32.

The fastener part 36 is threaded such as being internally threaded. By being internally threaded, an externally threaded part of the above-noted tool is threadedly secured to the fastener part 36 and then rotated to move a distal end 46 of the fastener part 36 towards the open end 28 of the part 36 thereby deforming an outer tubular sleeve 48 of the fastener part 36 to form a second annular flange 50 having the holding face 42. Preferably, the outer surface of the sleeve 48 includes a plurality of circumferentially spaced knurls 52 which form locking formations on the holding face 42 of the annular flange 50 to further prevent rotary motion of the fastener component 24 relative to the first outer layer 16.

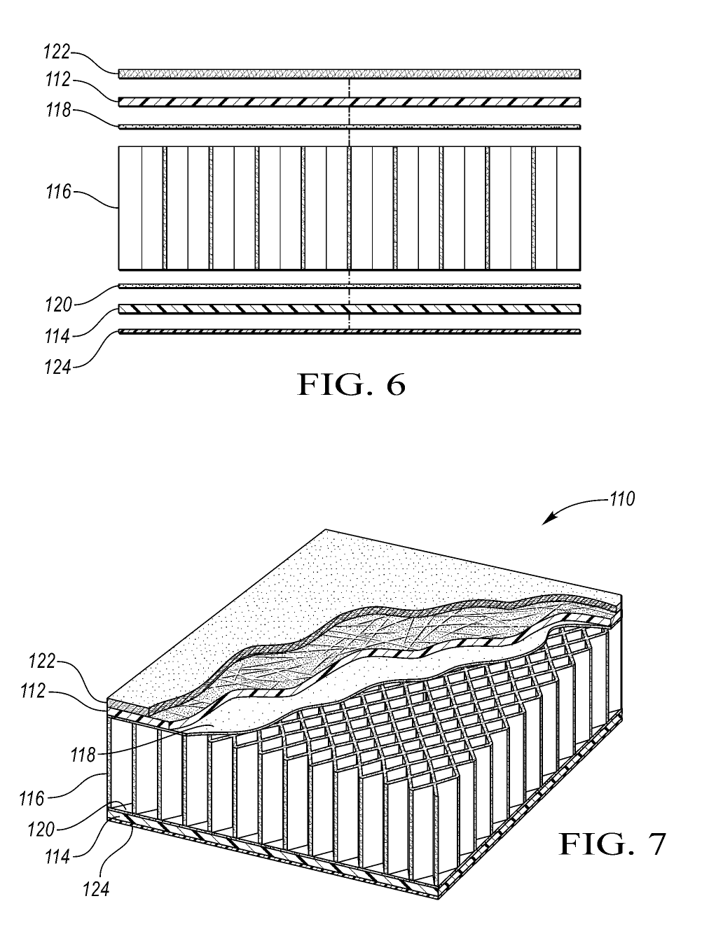

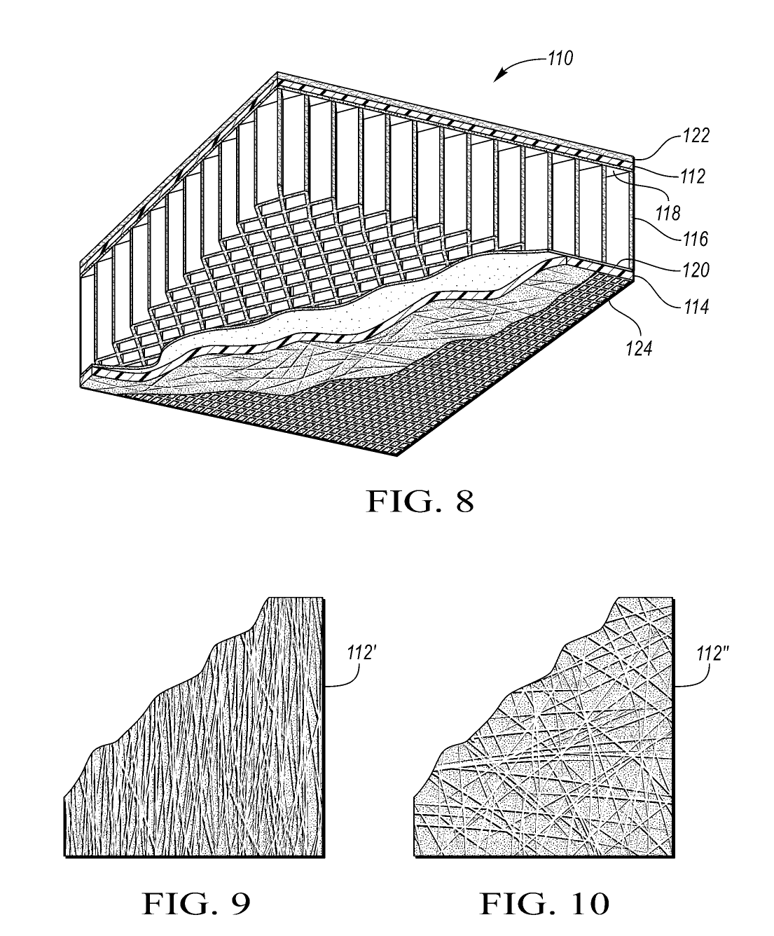

Referring now to the FIGS. 7 and 8, a second embodiment of a compression-molded, sandwich-type composite panel, generally indicated at 110, is shown. FIG. 6 shows a stack of thermoplastic-based and cellulose-based sheets or layers of material prior to the stack being compression molded into the composite panel or component 110. The panel 110 has a fastener component (not shown in FIGS. 7 and 8 but shown at reference numeral 14 in FIGS. 1-5) and forms a separate part of the vehicle. However, it is to be understood that one or more of such panels constructed in accordance with at least one embodiment of the present invention may be used in a wide variety of environments besides the automotive vehicle environment of FIG. 1. For example, the panel 110 may be a load-bearing vehicle component as shown or an interior trim component.

The panel 110 is typically manufactured via a thermo-compression process by providing the stack of material located or positioned within a low pressure, thermo-compression mold. As shown in FIG. 6, the stack includes first and second reinforced thermoplastic skins or outer layers 112 and 114, respectively, a cellulose-based core having a large number of cavities such as a paper or cardboard cellular core 116 disposed between and bonded to plys or films or sheets of hot-melt adhesive (i.e. thermoplastic adhesive) 118 and 120 which, in turn, are disposed between and bonded to the skins 112 and 114 by the press or compression molding. The sheets 118 and 120 may be bonded to their respective skins 112 and 114 prior to the press molding or are preferably bonded during the press molding. The thermoplastic of the sheets 118 and 120 is typically compatible with the thermoplastic of the skins 112 and 114 so that a strong bond is formed therebetween. One or more other resins may also be included within the adhesive of the sheets 118 and 120 to optimize the resulting adhesive system. The adhesive system is not a solvent-based adhesive system.

An optional substantially continuous covering or carpet layer, generally indicated at 122, made of thermoplastics material covers the first skin 112. The skins 112 and 114 and their respective sheets or film layers 118 and 120 (with the core 116 in between the layers 118 and 120) are heated typically outside of the mold (i.e. in an oven) to a softening temperature wherein the hot-melt adhesive becomes sticky or tacky. The mold is preferably a low-pressure, compression mold which performs a thermo-compression process on the stack of materials.

The step of applying the pressure compacts and reduces the thickness of the cellular core 116 and top and bottom surface portions of the cellular core 116 penetrate and extend into the film layers 118 and 120 without penetrating into and possibly encountering any fibers located at the outer surfaces of the skins 112 and 114 thereby weakening the resulting bond. Often times the fibers in the skins 112 and 114 are located on or at the surfaces of the skins as shown by skins 112′ and 112″ in FIGS. 9 and 10, respectively, wherein the fibers are substantially parallel and randomly oriented, respectively.

The carpet layer 122 may be a resin carpet and the resin may be polypropylene. The carpet layer 122 may be made of a woven or nonwoven material (typically of the carpet type).

An optional bottom layer of the panel 110 comprises a decorative, noise-management, covering layer 124 bonded to the bottom surface of the panel 110 to provide sound insulation and an aesthetically pleasing appearance to the bottom of the panel 110 if and when the bottom of the panel 116 is exposed to a passenger of the vehicle or others. In other words, the covering layer 124 reduces the level of undesirable noise in a passenger compartment of the vehicle.

The cellulose-based, cellular core 116 may be a honeycomb core. In this example, the cellular core has an open-celled structure of the type made up of a tubular honeycomb, and it is made mainly of cellulose and preferably of paper or cardboard. The sticky or tacky hot-melt adhesive extends a small amount into the open cells during the thermo-compression process. It is also possible to use a cellular structure having closed cells, a material, such as a wooden part, to which the top and bottom film layers 118 and 120, respectively, are bonded.

Each of the skins 112 and 114 may be fiber reinforced. The thermoplastic of the sheets or film layers 118 and 120, the skins 112 and 114, and the covering layers 122 and 124 may be polypropylene. Alternatively, the thermoplastic may be polycarbonate, polyimide, acrylonitrile-butadiene-styrene as well as polyethylene, polyethylene terphthalate, polybutylene terphthalate, thermoplastic polyurethanes, polyacetal, polyphenyl sulphide, cyclo-olefin copolymers, thermotropic polyesters and blends thereof. At least one of the skins 112 or 114 may be woven skin, such as polypropylene skin. Each of the skins 112 and 114 may be reinforced with fibers, e.g., glass fibers, carbon fibers, aramid and/or natural fibers. At least one of the skins 112 and 114 can advantageously be made up of woven glass fiber fabric and of a thermoplastics material.

The resulting panel 110 may have a thickness in the range of 5 to 25 mm.

In one example method of making the panel 110, a stack of material may be pressed in a low pressure, cold-forming mold (not shown). The stack is made up of the first skin 112, the first film layer 118, the paper cellular core 116, the second film layer 120, the second skin 114 and the covering layers 122 and 124, and is pressed at a pressure lying in the range of 10×10⁵ Pa. to 30×10⁵ Pa. The first and second skins 112 and 114, and the first and second film layers 118 and 120 are preferably pre-heated to make them malleable and stretchable. Advantageously, in order to soften the first and second skins 112 and 114, and their respective film layers 118 and 120, respectively, heat is applied to a pre-assembly made up of at least the first skin 112, the first film layer 118, the paper cellular core 116, the second skin 114 and the second film layer 120 so that, while the panel 110 is being formed in the mold, the first and second skins 112 and 114 and the film layers 118 and 120 have a forming temperature lying approximately in the range of 160° C. to 200° C., and, in this example, about 180° C.

The covering layer 122 is substantially continuous and may be formed from separate pieces of thermoplastic resin carpet which are subsequently bonded or fused together, such as by heat and/or pressure to carpet the entire top surface of the panel 110.

The bottom layer 124 of the panel 110 may be made of a nonwoven scrim 124 of fine denier, spunbond thermoplastic (i.e., polypropylene and/or polyester or other thermoplastic compatible to the process) fibers in the form of a sheet and having a weight in a range of 8 to 100 gsm (i.e., grams per square meter). Preferably, the weight is in a range of 17 to 60 gms. Also, preferably, the denier is in a range of 1.8 to 2.2.

The scrim 124 has an open mesh of nonwoven synthetic thermoplastic fibers including a plurality of adjacent openings. The scrim 124 both transmits light to the underlying layer and reflects light while reducing the level of undesirable noise from a different area of the vehicle. The scrim 124 may be manufactured in a color which is substantially the same, complements or is in contrast with the color of the upper carpet 122. Also, the panel 110 including the underlying scrim layer 124 and the carpet 122 can be made in a single compression molding step.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An assembly comprising:
a compression-molded composite component having a sandwich structure, the component including:
a first outer layer of fiber-reinforced thermoplastic material;
a first sheet of thermoplastic adhesive;
a second outer layer of fiber-reinforced thermoplastic material;
a second sheet of thermoplastic adhesive; and
a core of a cellulose-based material and positioned between the outer layers and having a large number of cavities wherein the outer layers are bonded to the core by the first and second sheets by press molding; and
at least one fastener component, each fastener component including:
a fastener part having a length and width; and
a mounting part mounting the fastener part to the first outer layer, the mounting part having a pair of holding faces that oppose each other and define a space therebetween, a portion of the first outer layer being positioned in the space in engagement with the faces to prevent the fastener part from moving along its length relative to the first outer layer.

2. The assembly as claimed in claim 1, wherein the holding faces are annular holding faces, the space is an annular space and the portion of the first outer layer is an annular portion.

3. The assembly as claimed in claim 1, wherein the length of the fastener part is greater than the width of the first outer layer but less than the width of the composite component.

4. The assembly as claimed in claim 1, wherein the fastener part is cylindrical and wherein the cylindrical fastener part has an axis defined as being central to the fastener part.

5. The assembly as claimed in claim 4, wherein at least one of the holding faces has a set of locking formations spaced about the axis of the fastener part to prevent rotary movement of the fastener component relative to the first outer layer.

6. The assembly as claimed in claim 4, wherein the holding faces are annular holding faces and wherein the annular holding faces are oriented to face axially along the axis.

7. The assembly as claimed in claim 1, wherein the fastener part is threaded.

8. The assembly as claimed in claim 7, wherein the fastener part is internally threaded.

9. The assembly as claimed in claim 1, wherein the thermoplastic adhesive of the sheets is a hot-melt adhesive.

10. The assembly as claimed in claim 1, wherein the first outer layer is a load-bearing layer.

11. The assembly as claimed in claim 10, wherein the composite component is a vehicle floor panel.

12. The assembly as claimed in claim 1, wherein the core is a paper cellular core.

13. The composite component as claimed in claim 12, wherein the core has a honeycomb structure.

14. The assembly as claimed in claim 1, further comprising an opening which extends completely through the first outer layer and at least partially extends through the core towards the second outer layer wherein the mounting part mounts the fastener component in the opening.

15. The assembly as claimed in claim 14, wherein the opening is a circular opening and the fastener component is a generally cylindrical component.

16. An assembly comprising:
a compression-molded composite component having a sandwich structure, the component including:
a first outer layer of a fiber-reinforced thermoplastic material and having a circular opening which extends completely through the layer;
a first sheet of thermoplastic adhesive;
a second outer layer of fiber-reinforced thermoplastic material;
a second sheet of thermoplastic adhesive; and
a core of a cellulose-based material and positioned between the outer layers and having a large number of cavities wherein the outer layers are bonded to the core by the first and second sheets by press molding; and
at least one fastener component, each fastener component being generally cylindrical and including:
a cylindrical, threaded fastener part having a length, a width and an axis defined as being central to the fastener part; and
a mounting part mounting the fastener part in the opening in the first outer layer, the mounting part having a pair of annular holding faces that oppose each other and are oriented to face axially along the axis, the holding faces defining an annular space therebetween, an annular portion of the first outer layer being positioned in the space in engagement with the faces to prevent the fastener part from moving along its axis relative to the first outer layer.

17. The assembly as claimed in claim 16, wherein the length of the fastener part is greater than the width of the first outer layer but less than the width of the composite component.

18. The assembly as claimed in claim 16, wherein each of the holding faces has a set of locking formations spaced about the axis of the fastener part to prevent rotary movement of the fastener component about the axis relative to the first outer layer.

19. A vehicle floor panel assembly comprising:
a compression-molded composite component having a sandwich structure, the component including:
a load-bearing, first outer layer of a fiber-reinforced thermoplastic material and having a circular opening which extends completely through the layer;
a first sheet of thermoplastic adhesive;
a second outer layer of fiber-reinforced thermoplastic material;
a second sheet of thermoplastic adhesive; and
a core of cellulose-based material and positioned between the outer layers and having a large number of cavities wherein the outer layers are bonded to the core by the first and second sheets by press molding; and
at least one fastener component, each fastener component being generally cylindrical and including:
a cylindrical, threaded fastener part having a length, a width and an axis defined as being central to the fastener part; and
a mounting part mounting the fastener part in the opening in the first outer layer, the mounting part having a pair of annular holding faces that oppose each other and are oriented to face axially along the axis, the holding faces defining an annular space therebetween, an annular portion of the first outer layer being positioned in the space in engagement with the faces to prevent the fastener part from moving along its axis relative to the first outer layer.

20. The assembly as claimed in claim 19, wherein at least one of the holding faces has a set of locking formations spaced about the axis of the fastener part to prevent rotary movement of the fastener component about the axis relative to the first outer layer.
